(19) United States
(12) Patent Application Publication
(10) Pub. No.: US 2010/0316201 A1
(43) Pub. Date: Dec. 16, 2010

(54) PRIVATE BRANCH EXCHANGE SYSTEMS AND METHODS

(76) Inventor: Jimmie Linden Miller, Banville, CA (US)

Correspondence Address: SQUIRE SANDERS & DEMPSEY LLP, 1 East Washington Street, SUITE 2700, PHOENIX, AZ, 85004, US

(21) Appl. No.: 12/484,016

(22) Filed: Jun. 12, 2009

(51) Int. Cl. H04M 11/00; H04M 7/00; H04M 3/42

(52) U.S. Cl. 379/93.01; 379/220.01; 379/202.01

(57) ABSTRACT

The present invention provides a full-featured telecommunications system without the cost and infrastructure requirements of conventional private branch exchange (PBX) systems. A system according to aspects of the present invention comprises a data processing unit and an application controller in communication with the data processing unit. The application controller comprises a processor, a user interface, and a memory coupled to the processor. The memory stores instructions that, when executed by the processor, cause the processor to receive a request for a communication through the data processing unit and instruct the data processing unit to perform the communication in accordance with the request.

### DESCRIPTION OF THE INVENTION

1. Field of the Invention

The present invention relates to private branch exchange (PBX) systems and methods. In particular, the present invention allows full-featured and scalable telecommunications solutions to be provided with a minimal level of infrastructure.

2. Background of the Invention

Today, PBX systems are widely used to route communications (such as voice and data) within a private organization, such as a business. A PBX system handles internal communications (e.g., between two extensions within the organization), as well as external communications (e.g., between an extension within the organization and a user or device outside the organization. PBX systems facilitate the communication between a variety of devices, such as computers, fax machines, telephones, and other systems and devices.

PBX systems allow private organizations to reduce costs on internal communications, and allow conference calling, content forwarding, delivery of content to groups within the organization, and other features that would be expensive or impossible without a PBX. However, conventional PBX systems are generally costly and time consuming to install and maintain. They require a substantial investment in switching hardware, wiring and cabling, and other infrastructure. Additionally, conventional PBX systems may be subject to varying costs to connect to external networks (such as a public switched telephone network or “PSTN”), whereby communications during peak business hours are the most expensive. Conventional PBX systems thus often represent a significant expense to larger businesses and organizations, and are often too complex and expensive for many smaller organizations to even consider. The present invention addresses these and other issues.

### SUMMARY OF THE INVENTION

Both the foregoing summary and the following detailed description are exemplary and explanatory only and are not restrictive of the invention as claimed.

The present invention provides a full-featured telecommunications system without the cost and infrastructure requirements of conventional private branch exchange (PBX) systems. A system according to aspects of the present invention comprises a data processing unit and an application controller in communication with the data processing unit. The application controller comprises a processor, a user interface, and a memory coupled to the processor. The memory stores instructions that, when executed by the processor, cause the processor to receive a request for a communication through the data processing unit and instruct the data processing unit to perform the communication in accordance with the request.

A system according to another aspect of the present invention comprises a plurality of data processing units and a plurality of application controllers in communication with the plurality of data processing units. Each application controller comprises a processor, a user interface, and a memory coupled to the processor. The memory stores instructions that, when executed by the processor, cause the processor to receive a request for a communication from one or more of the data processing units; and instructing one or more of the plurality of data processing units to perform the communication in accordance with the request.

### BRIEF DESCRIPTION OF THE DRAWINGS

A more complete understanding of the present invention may be derived by referring to the detailed description and claims when considered in connection with the following illustrative figures.

FIG. 1 is a block diagram depicting an exemplary system according to various aspects of the present invention.

FIG. 2 is a block diagram depicting an exemplary data processing unit from the system illustrated in FIG. 1.

FIG. 3 is a block diagram depicting an exemplary application controller from the system illustrated in FIG. 1.

FIG. 4 is a block diagram depicting an exemplary communications device from the system illustrated in FIG. 1.

FIGS. 5-7 are a flow diagrams depicting exemplary processes according to various aspects of the invention.

### DETAILED DESCRIPTION OF EXEMPLARY EMBODIMENTS

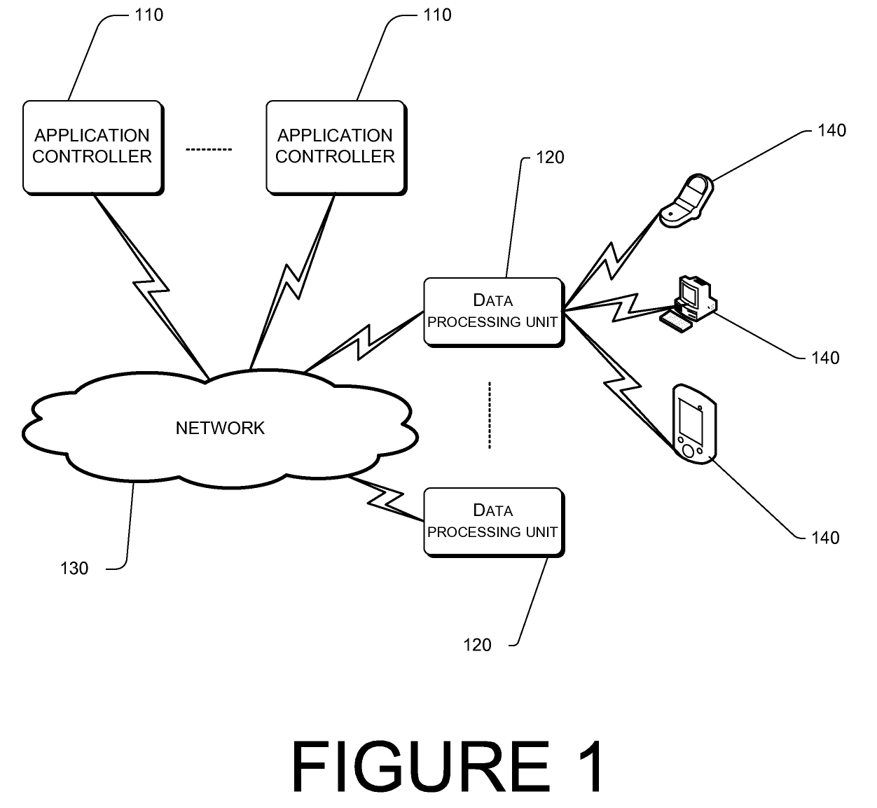

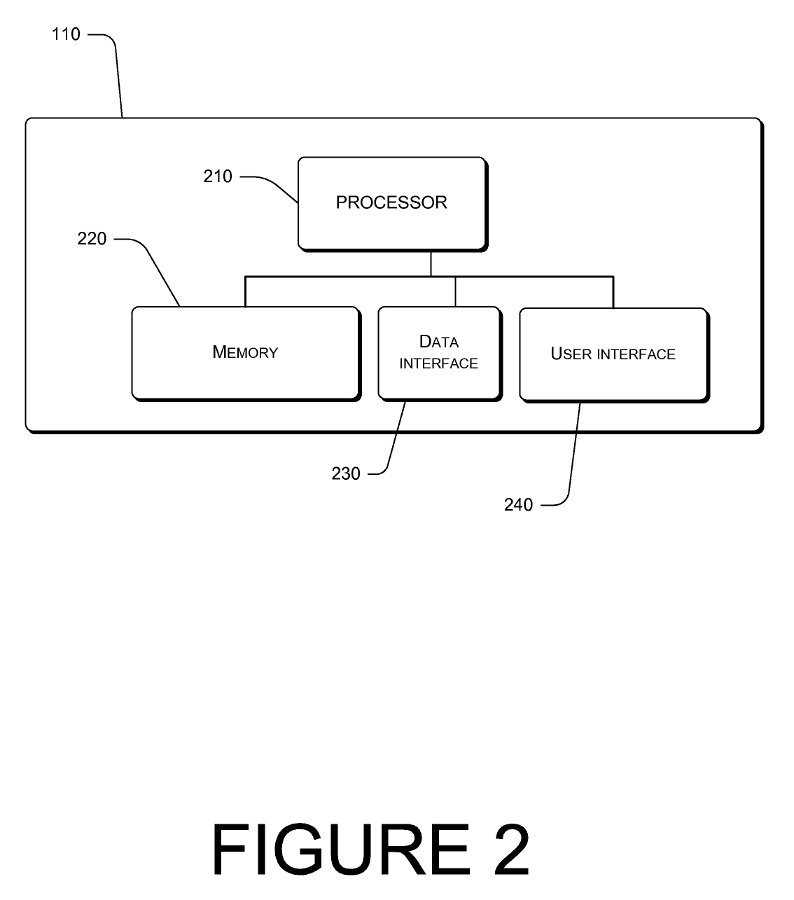

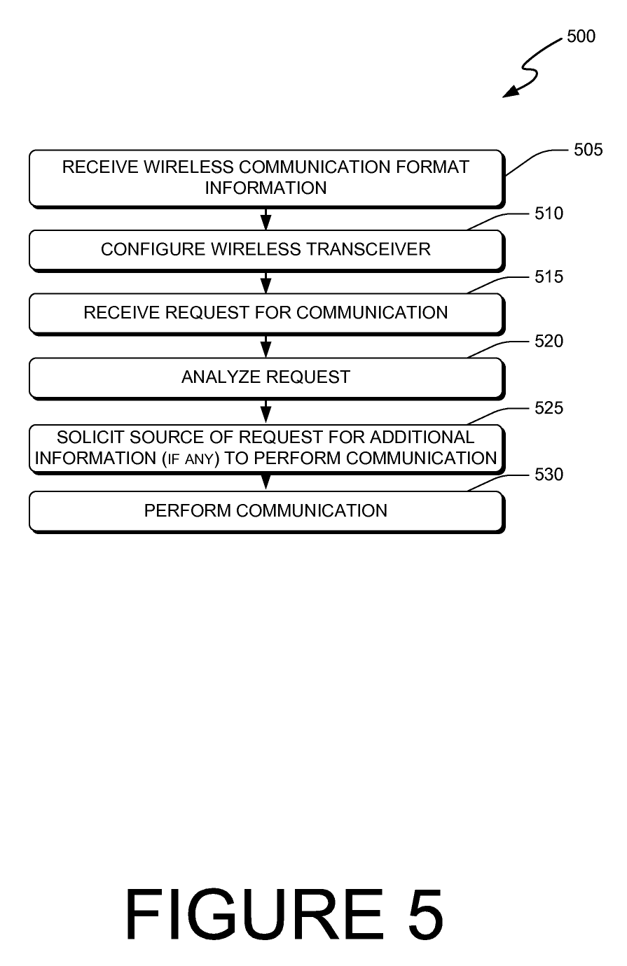

An exemplary system for use in conjunction with the present invention is depicted in FIG. 1. This system may be used in conjunction with the systems described in FIGS. 2-4, the methods described in FIG. 5-7, as well as any subset or combination of the elements thereof. The system shown in FIG. 1 may also be used in conjunction with any other suitable embodiments of the present invention.

As discussed in more detail below, this system provides a full-featured telecommunications system without the cost and infrastructure requirements of conventional private branch exchange (PBX) systems. The exemplary PBX system of the present invention depicted in FIG. 1 comprises one or more application controllers 110 in communication with one or more data processing units 120 through a network 130. In this exemplary system, the data processing units 120 can be dynamically shared among, or dedicated to, the application controllers 110. Multiple application controllers 110 may be managed by one or more data servers (not shown).

Among other things, this allows telecommunication features to be provided to application controllers 110 as needed, allowing the system to maintain full functionality even during peak usage periods. The data processing units 120 can be configured to communicate with a variety of communications systems 140 and through a variety of communication methods. In one embodiment of the present invention, the data processing units 120 utilize existing cellular networks to communicate with the communication systems 140, avoiding the need for the costly wiring and infrastructure required for conventional PBX systems.

### Application Controller 110

The application controller 110 schedules, directs, and manages communications and resources for the PBX system. The application controller 110 can function as a stand-alone controller for a PBX, or may be directed by another system or device, such as a data server. In one exemplary embodiment of the present invention, a data server manages a plurality of application controllers 110. Any number of such data servers may operate together in accordance with the present invention. In one embodiment, a data center comprising a plurality of data servers control application controllers 110 and provide users with information in real time or on demand. The data servers can provide any desired information, such as company material that is only available to authorized users, e-mail, conference information, address books, sales information, product information, billing information, messaging, and/or any other desired data. The information provided by a data server can be both interactive and dynamic, so that, for example, a sales team could order or sell resources. The information provided by data servers can be accessed by a user in any desired manner, such as through a user interface.

FIG. 2 depicts an exemplary application controller 110, which includes a processor 210, memory 220, data interface 230, and user interface 220. The application controller 110 may comprise, or operate in conjunction with any number and type of conventional computer, computer system, computer network, computer workstation, minicomputer, mainframe computer, or computer processor, such as an integrated circuit microprocessor or microcontroller. Computer systems used in accordance with aspects of the present invention may include an operating system (e.g., Windows NT, 95/98/2000/XP/Vista, OS2, UNIX, Linux, Solaris, MacOS, etc.) as well as various conventional support software and drivers typically associated with computers. The application controller 110 schedules and directs communications performed using the data processing units 120. The application controller 110 also manages the configuration and allocation and de-allocation of data processing units 120 to allow, for example, for additional resources to be available during periods of peak demand.

In the exemplary application controller 110 depicted in FIG. 2, the processor 210 retrieves and executes instructions stored in the memory 220 to control the operation of the application controller 110. Any number and type of processor such as an integrated circuit microprocessor, microcontroller, and/or digital signal processor (DSP), can be used in conjunction with the present invention.

The memory 220 stores instructions and data. A memory 220 operating in conjunction with the present invention may include any combination of different memory storage devices, such as hard drives, random access memory (RAM), read only memory (ROM), FLASH memory, or any other type of volatile and/or nonvolatile memory. Data can be stored in the memory 220 in any desired manner. The application controller 110 may include, or be in communication with, one or more databases storing information pertaining to the operation of the PBX system of the present invention.

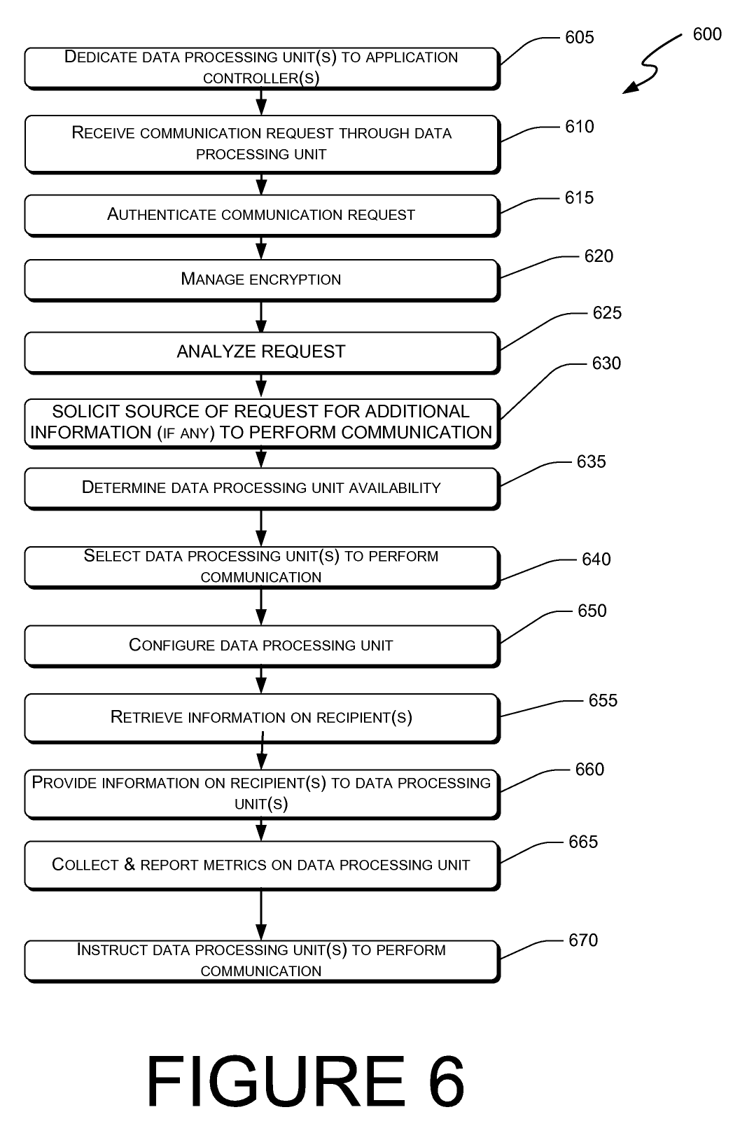

The functionality of the application controller 110, including the method depicted in FIG. 6 (in whole or in part), may be implemented through the processor 210 executing computer-readable instructions stored in the memory 220 of the application controller 110. The memory 220 may store any computer-readable instructions and data, including software applications, applets, and embedded operating code. The functionality of the application controller 110 may also be implemented through various hardware components storing machine-readable instructions, such as application-specific integrated circuits (ASICs), field-programmable gate arrays (FPGAs) and/or complex programmable logic devices (CPLDs). Systems according to aspects of the present invention may operate in conjunction with any desired combination of software and/or hardware components. In one exemplary embodiment of the present invention, an application controller 110 includes an FPGA to perform audio processing and message handling/routing, and to communicate with multiple data processing units 120. This can aid in reducing latency to and from the applications controller 110.

The data interface 230 communicates with one or more data processing units 120, networks 130, other application controllers 110, or other suitable entities. The application controller 110 can communicate directly with other entities (such as one or more data processing units 120) as well as through one or more intermediaries (such as through network 130). Any suitable communications device, component, system, and method may be used in conjunction with the data interface 230 of the present invention. The data interface 230 may communicate in any desired manner, such as through a serial connection (such as I2C, I2S, Serial Peripheral Interface (SPI) and the like), a wired Internet connection, a wireless Internet connection, a cellular telephone network connection, a wireless LAN connection, a wireless WAN connection, an optical connection, and/or a USB connection.

The application controller 110 depicted in FIG. 2 includes a user interface 240. The user interface 240 may include any number of input devices (not shown) to receive commands, data, and other suitable input from a user, as well as any number of output devices (not shown) to provides the user with data, notifications, and other suitable information.

Any number of input devices may be included in the user interface 240 such as a touch pad, a touch screen, and/or an alphanumeric keypad to allow a user to enter instructions and data into the application controller 110. The user interface 240 may also include a microphone to allow the user to provide audio data to the application controller 110, as well as a camera to allow the application controller 110 to capture still or video images. The application controller 110 may include speech recognition software to process verbal input through the user interface 240.

The user interface 240 may also include any number of suitable output devices, such as a display screen to visually display information (such as video and text), and/or a speaker to provide auditory output. The application controller 110 may be configured to provide words, phrases, tones, recorded music, or any other type of auditory output to a user through the speaker.

The user interface 240 may further include one or more biometric devices configured to receive biometric information and limit access to the application controller 110 to authorized users. Such biometric devices can include a fingerprint scanner, an iris scanner, a retinal scanner, and/or a breath analyzer. Input devices such as a microphone or camera may also be utilized to perform biometric analyses, such as a voice analysis or facial recognition.

An exemplary method that may be used in conjunction with the application controller 110 is depicted in FIG. 6. In this exemplary method (600), the application controller 110 dedicates one or more data processing units 120 to itself and/or to other application controllers 110 (605), receives a communication request via a data processing unit 120 (610), authenticates the communication request (615), and manages encryption for the communication (620). The communication request can be analyzed (625) and, if additional information is needed, it can be solicited from the source of the communication request (630). The availability of a data processing unit 120 to perform the communication is determined (635) and one or more data processing units 120 are selected to perform the communication (640) and configured (650). Information on a recipient may be retrieved (655) and provided (660) to one or more data processing units 120. Metrics on a data processing unit 120 can be collected and reported (665), and one or more data processing units 120 instructed to perform the communication (670).

As depicted in FIG. 1, an application controller 110 can be in communication with, and utilize the resources of, any number of data processing units 120. These data processing units 120 can either be dedicated (605) to a single application controller 110 or shared between any number of application controllers 110. In this manner, an application controller 110 experiencing a high demand for communication resources can dynamically allocate such resources as needed. Conversely, an application controller 110 who is not utilizing the resources of a data processing unit 120 can free those resources for use by other application controllers 110. Unlike conventional PBX systems where communication resources are statically allocated (and thus usually underutilized or overutilized), the dynamic allocation of data processing units 120 in the PBX of the present invention provides for the efficient, scaleable, and cost-effective allocation of communications capability.

Communication requests issued by communication devices 140 are subsequently received by an application controller 110 through one or more data processing units 120 (610). The application controller 110 can receive a request for any type of communication, such as an electronic mail message, an SMS text message, a facscimile, an audio communication, a voice message, a video communication, a group communication, a conference communication, and combinations thereof. In the context of this application, a “group communication” may include any communication distributed to a plurality of recipients and a “conference communication” may include any communication where a plurality of attendees communicate with each other. Exemplary conference communications may include a spontaneous conference communication, a bridge conference communication, a reach-out conference communication, a multi-location communication, and combinations thereof. These conference communications are discussed in more detail below. Additionally, the application controller 110 may transmit messages and/or data to any other desired system, device, or other entity.

The communication can be of any desired format. For example, the communication may comprise a file having a tokenized format such as standard ASCII text format, or any other suitable standardized file format, such as an MS Word document, MS Excel file, Adobe PDF file, or binary picture file (JPEG, bitmap, etc.). The data within such a file can be ordered in any manner and have any suitable delimiters, notations, or other features. The communication may also have a unique and/or propriety format.

The application controller 110 may authenticate a communication request (615) in any desired manner, such as by verifying the identity of a communications device 140 (or user of such a device) sending the request. For example, the application controller 110 can compute a digest of the communication request and compare the digest value to a previously stored authorization digest value. The computed digest value may be produced by providing the received request to a hashing algorithm such as the MD5 or SHA-1 Secure Hashing Algorithm as specified in National Institute of Standards and Technology Federal Information Processing Standard Publication Number 180-1, the disclosure of which is incorporated by reference herein in its entirety. The authorization digest value can be any number, code, value, or identifier that allows a received message to be identified as a valid transmission from an authorized data processing unit 120 and/or communications device 140. Unless the authorization digest value matches the stored digest value, the communication request will not be authenticated and can be disregarded (if desired).

The application controller 110 may be configured to implement one or more security measures to protect data, restrict access, or provide any other desired security feature. For example, an application controller 110 may encrypt transmitted data and/or data stored within the application controller 110. Such security measures may be implemented using hardware, software, or a combination thereof. Any method of data encryption or protection may be utilized in conjunction with the present invention, such as public/private keyed encryption systems, data scrambling methods, hardware and software firewalls, tamper-resistant or tamper-responsive memory storage devices or any other method or technique for protecting data. Similarly, passwords, biometrics, access cards or other hardware, or any other system, device, and/or method may be employed to restrict access to any device operating in conjunction with the present invention.

The application controller 110 may also manage encryption for the communication request and/or communication itself (620). For example, the application controller 110 can decrypt at least part of the message with a public key associated with the sender of a communication (e.g., an authorized communications device 140) as part of an asymmetric encryption algorithm. Asymmetric encryption algorithms and techniques are well known in the art. See, e.g., RSA & Public Key Cryptography, by Richard A. Mollin, CRC Press, 2002, and U.S. Pat. No. 4,405,829, issued Sep. 20, 1983, the disclosures of which are fully incorporated by reference herein. Additionally, full two-way public encryption can be used to authenticate that the source of the communication request is a valid communications device 140. Alternatively, communications and communication requests may be encrypted with only the private keys of the sending entity, and decrypted with the public keys to expedite processing time.

In alternate embodiment, encrypted or unencrypted data can be transmitted to and from the application controller 110 through an encrypted transmission protocol, such as the wireless encryption protocols (WEP, WPA and WPA2) associated with the IEEE 802.11 wireless protocols. Any number of other encryption methods can be used to encrypt data communicated to and from the application controller 110 in conjunction with the present invention.

The request can be analyzed (625) and, in the event that the request does not include information necessary to perform the communication, soliciting the source of the request (e.g., a communications device 140) for the necessary information (630). For example, in an embodiment of the present invention a communications device 140 contacts an application server 110 via a data processing unit 120 to request a communication. The communications device 140, communicating with the data processing unit 120 through a cellular data connection, provides information necessary to verify the user of the communications device 140, as well as information identifying one or more recipients for the communication. The application controller 110 analyzes the communication request and determines whether enough information was provided by the communications device 140 to perform the communication. If, for example, the communication is a group communication and the communications device 140 provides the identity of the group, the application controller 110 attempts to identify the members of the group and retrieve their address information from a database stored in the memory 220. If, however, the application controller 110 cannot identify the group members, it can solicit the communications device 140 for the address information of the members.

The application controller 110 determines which of the data processing units 120 it is in communication with are available to perform the communication (635) and selects one or more data processing units 120 to perform the communication in accordance with the communication request (640). Among other things, this can help the application controller 110 minimize the costs of performing communications and efficiently allocating the resources of the data processing units 120.

The application controller 110 can select a data processing unit 120 from a plurality of data processing units 120 based on any desired criteria. For example, where the communication requires that a data processing unit 120 communicate in a particular communication format, the application controller 110 can select from available data processing units 120 capable of communicating in that format. Additionally, the application controller 110 can compare the cost of communicating via a wireless carrier associated with various data processing units 120 in order to minimize the cost of the communication.

The application controller 110 may also consider the physical location of a data processing unit 120 to, for example, minimize data latency and/or to minimize the costs of the communication. For example, the application controller 110 can consider a location as a geographical area defined by a boundary, an area corresponding to a postal code, and/or an area corresponding to a telephone area code. The location of the data processing unit 120 may be compared to a database that tracks communication costs for utilizing the data processing unit 120 for various types of communications and at various times of day. Users of the PBX system of the present invention in different geographical regions (e.g., employees of a company with multiple offices) can perform cross-site group communications as if they were each part of the same local PBX system. Many conventional PBX systems, by contrast, are site-specific and do not have visibility into users of PBX systems at other sites.

The application controller 110 may also select a data processing unit based on the usage status of the data processing units 120. For example, the application controller 110 may select a data processing unit 120 that is idle or experiencing a relatively low level of communication requests from other application controllers 110 over a data processing unit 120 that is processing a relatively high volume of communications.

The application controller 110 can configure and control a data processing unit 120 (650). For example, the application controller 110 can configure a data processing unit to communicate using a particular wireless communications format (see the data processing unit 120 description below for some exemplary communication formats). The application controller 110 can configure a data processing unit 120 automatically, as well as in accordance with commands from a user through the user interface 240. The application controller 110 can also retrieve information on the status of a data processing unit 120. This information can be used for any suitable purpose, such as to determine which data processing unit 120 to instruct to perform a communication. The information on the status of a data processing unit 120 can also be reported to a user through the user interface 240 and/or stored in a database to gather metrics on the performance of the PBX system as described below.

The application controller 110 can also configure one data processing unit 120 to communicate in a first communication format and configure another data processing unit 120 to communicate in a second communication format. The application controller 110 may further configure a portion of data processing units 120 it is in communication with to be dedicated to that application controller 110 for a predetermined period of time. Among other things, this helps ensure that adequate resources will be available to the application controller 110 during periods of heavy communication traffic. An application controller 110 can also share data processing units 120 with other application controllers 110 to allow data processing units 120 to be dynamically allocated as needed by individual application controllers 110. The application controller 110 may configure any other suitable features of a data processing unit 120.

The application controller 110 may retrieve information on one or more recipients of a communication (655) and provide this information to one or more data processing units 120 (660). The information on the recipients of the communication may include, for example, a group identifier associated with the recipient, a number or other identifier associated with a communications device (such as a telephone, facsimile machine, or pager) or its user(s), an email address, a uniform resource identifier (URI), a uniform resource locator (URL), an internet protocol (IP) address, and/or any other information that can be used by a data processing unit 120 in performing a communication.

The application controller 110 can collect and report metrics pertaining to one or more data processing units 120 (665). Such metrics can be stored in the memory 220 (e.g., in a relational database) and provided to a user through the user interface 240. Among other things, the collection and review of metrics can help identify periods of increased or decreased usage for a particular application controller 110 and to ensure that an adequate number of data processing units 120 are available to handle all communication requests for a particular application controller 110.

The application controller 110 instructs one or more data processing units 120 to perform the communication (670). The communication is generally performed In accordance with the communication request, but may be modified and/or managed by the application controller 110. For example, in the case of a conference voice communication, the application controller 110 mixes audio from each of a plurality of conference attendees.

### Data Processing Unit 120

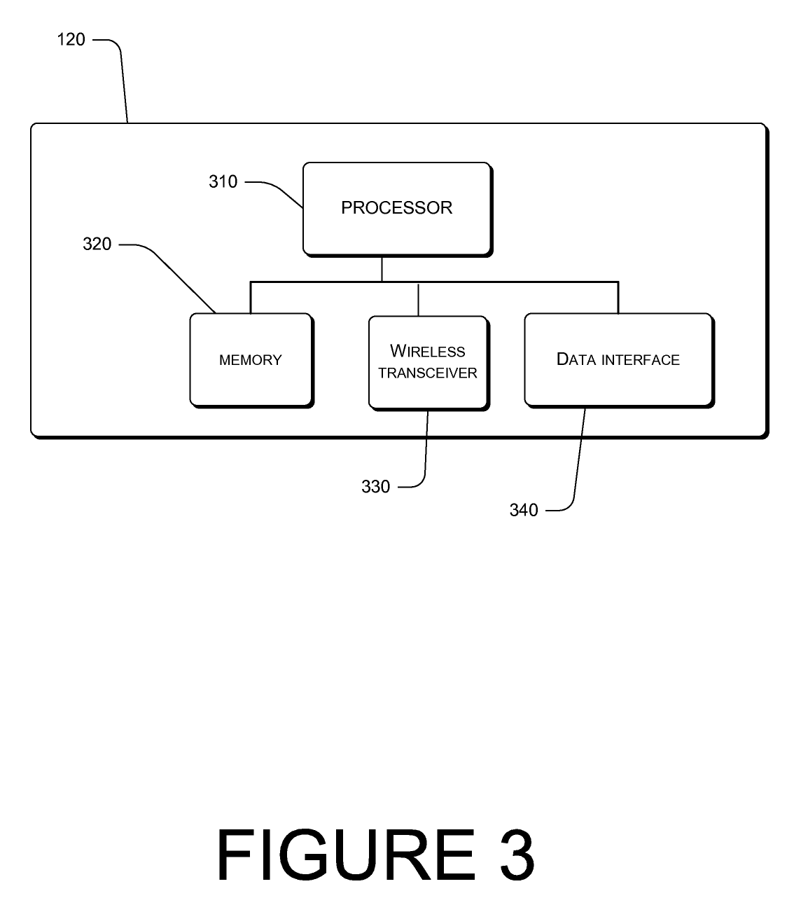

FIG. 3 depicts and exemplary data processing unit 120, which includes a processor 310, memory 320, wireless transceiver 330, and data interface 340. The data processing unit 120 provides communication functionality to the PBX system of the present invention. Any number of data processing units 120 can be networked to an application controller 110, and can be allocated and de-allocated to an application controller 110 dynamically.

The processor 310 retrieves and executes instructions stored in the memory 320 to control the operation of the data processing unit 120. Any number and type of processor such as an integrated circuit microprocessor, microcontroller, and/or digital signal processor (DSP), can be used in conjunction with the present invention.

The memory 320 stores instructions and data. A memory 320 operating in conjunction with the present invention may include any combination of different memory storage devices, such as hard drives, random access memory (RAM), read only memory (ROM), FLASH memory, or any other type of volatile and/or nonvolatile memory. Data can be stored in the memory 320 in any desired manner. The functionality of the data processing unit 120, including the method depicted in FIG. 5 (in whole or in part), may be implemented through the processor 310 executing computer-readable instructions stored in the memory 320. The memory 320 may store any computer-readable instructions and data, including software applications, applets, and embedded operating code. The functionality of the data processing unit 120 may also be implemented through various hardware components (alone or in combination with software) as described previously for the application controller 110.

The wireless transceiver 330 performs communications and can communicate in any desired manner. For example, the wireless transceiver 330 may be configured to communicate using any number and type of cellular networks and protocols, such as General Packet Radio Service (GPRS), Global System for Mobile Communications (GSM), Enhanced Data rates for GSM Evolution (EDGE), Personal Communication Service (PCS), Advanced Mobile Phone System (AMPS), Code Division Multiple Access (CDMA), Wideband CDMA (W-CDMA), Time Division-Synchronous CDMA (TD-SCDMA), Universal Mobile Telecommunications System (UMTS), and/or Time Division Multiple Access (TDMA). A data processing unit 120 operating in conjunction with the present invention may alternatively (or additionally) include wireless transceiver(s) (and related components) to communicate using any other method of wireless communication protocol, such as a Bluetooth protocol, an IEEE 802.15 protocol, an IEEE 802.11 protocol, an IEEE 802.16 protocol, an ultra-wideband (UWB) protocol, and combinations thereof.

By utilizing wireless communication methods, the PBX system of the present invention can be implemented without the extensive infrastructure requirements of conventional PBX systems. Additionally, the use of cellular networks can significantly reduce communications costs. For example, costs to route communications through landlines can be avoided, and special usage plans offered by cellular providers can be utilized. Such plans commonly include “evening,” “anytime,” and roll-over minutes, as well as free mobile-to-mobile calling, and free night and weekend communications. An application controller 110 and/or data processing unit 120 may also be configured to communicate using voice over internet protocol (VOIP) networks to take advantage of similar cost savings over conventional land-line communications.

Where a data processing unit 120 has the capability to communicate in multiple formats, an application controller 110 can configure the data processing unit 120 to communicate in one or more wireless communication formats. A data processing unit 120 may include any number of wireless transceivers 330 to, for example, simultaneously handle an incoming communication from a first communications device 140 and connect the first device to one or more other communications devices 140.

The data processing unit 120 utilizes the data interface 340 to transfer data received or transmitted using the wireless transceiver 330. Additionally, the data interface 340 may be used to configure and/or control the data processing unit 120. In one embodiment of the present invention, an application controller 110 instructs the data processing unit 120 to perform a communication in accordance with a communication request provided to the data processing unit 120 through the data interface 340. Additionally, an application controller 110 can provide information pertaining to a wireless communications format to the data processing unit 120 and configure the data processing unit 120 to communicate in one or more wireless communication formats.

An exemplary method that may be used in conjunction with a data processing unit 120 is depicted in FIG. 5. In this exemplary method (500), information for one or more wireless communication formats is received (505), and the wireless transceiver 330 is configured (510). A request for a communication is received (515) and analyzed (520), and additional information is solicited from the requester if needed (525). Additionally, the data processing unit 120 can perform a communication (530), whether directly in response to a request received from a communications device 140 or upon instruction from another entity (such as the application controller 110).

As discussed previously, a data processing unit 120 operating in conjunction with the present invention can perform any suitable form of communication, such as conference communications. Exemplary conference communications may include a spontaneous conference communication, a bridge conference communication, a reach-out conference communication, a multi-location communication, and combinations thereof.

As used herein, a multi-location communication may include any communication directed to multiple locations. In one exemplary embodiment, recipients of a multi-location communication can be contacted simultaneously (e.g., via ring tones to multiple communications devices 140). A user attempting to contact multiple recipients in this manner may be provided periodic status information regarding the simultaneous contact attempts.

In a reach-out conference communication, the user specifies a recipient of a communication, and the application controller 110 and/or data processing unit 120 automatically attempts to contact the recipient at a plurality of addresses associated with the recipient. In this manner, a user need only identify the recipient once (instead of manually attempting to contact a series of addresses for the recipient) and the PBX system will automatically try to contact the recipient.

In a spontaneous conference communication, a user of a communications device 140 requests a conference communication (such as a voice or data communication) involving multiple locations. In one embodiment, the communications device 140 establishes a connection with an application controller 110 via a data processing unit 120 via a cellular network connection. The application controller 110 instructs one or more data processing units 120 to attempt to contact attendees and join them to the conference communication. The user receives status information regarding the connection (or failed attempt to connect) of each attendee to the conference, which is presented through the user interface 430 of the communications device 140.

A bridge conference communication operates similarly to the spontaneous conference, and involves a user requesting a future conference communication involving multiple locations. In response to the communication request, the application controller 110 provides a bridge identifier and passcode to the user. Attendees of the conference will likewise be provided contact information to attend the conference. Attendees and the user can also be provided with reminders (via a calendar software program, for example) pertaining to the conference. Once the conference time has arrived, status updates can be periodically provided to the user.

### Network 130

In one embodiment, components of the present invention (such as the application controllers 110 and data processing units 120) may communicate with each other, and other systems and devices, through a network 130. Any suitable network may be used in conjunction with the present invention, such as a wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network. Systems and devices operating in conjunction with the present invention may also communicate with other systems and devices through any other type of connection, such as a wired Internet connection, a wireless Internet connection, a cellular telephone network connection, a wireless LAN connection, a wireless WAN connection, an optical connection, and/or a USB connection. The network 130 can communicate using any of the communication formats listed above for the application controller 110 and data processing unit 120.

### Communications Device 140

Any number and type of communications devices 140 may communicate with one or more data processing units 120. A communications device 140 may include any system or device capable of communicating with a data processing unit 120 and/or application controller 110. A communications device 140 may be a stand-alone device such as a laptop computer, a desktop computer, a mobile subscriber communication device, a mobile phone or telephone handset, a personal digital assistant (PDA), a data tablet, and combinations thereof. A communications device 140 may also be integrated with another system or device. Software to implement methods of the present invention can be (1) installed on, or (2) downloaded onto a communications device 140 indirectly or directly at any time through the Internet, SMS text message, or in any other suitable manner and at any suitable time for carrying out a method according to the invention.

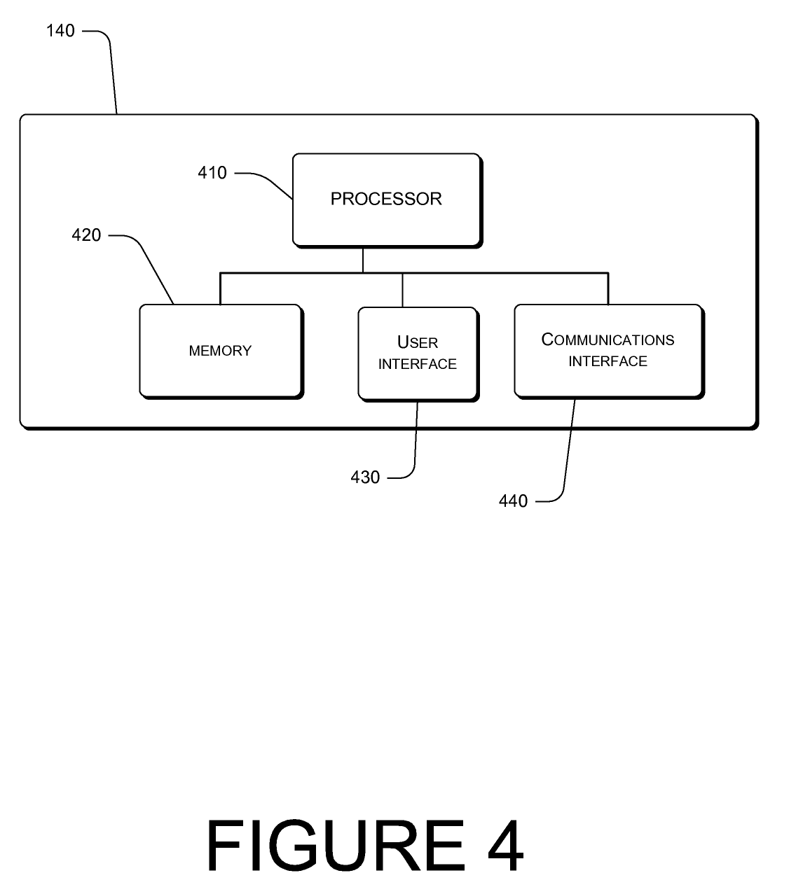

An exemplary communications device 140 is depicted in FIG. 4, and includes a processor 410, memory 420, user interface 430, and communications interface 440. The processor 410 retrieves and executes instructions stored in the memory 420 to control the operation of the communications device 140. Any number and type of processor may be used, as described for the processors of the application controller 110 and data processing unit 120. The memory 420 stores instructions and data and may include any combination of different memory storage devices, such as a those described above for the application controller 110 and data processing unit 120. The memory 420 may be integrated with another system or device, such as a subscriber identity module (SIM).

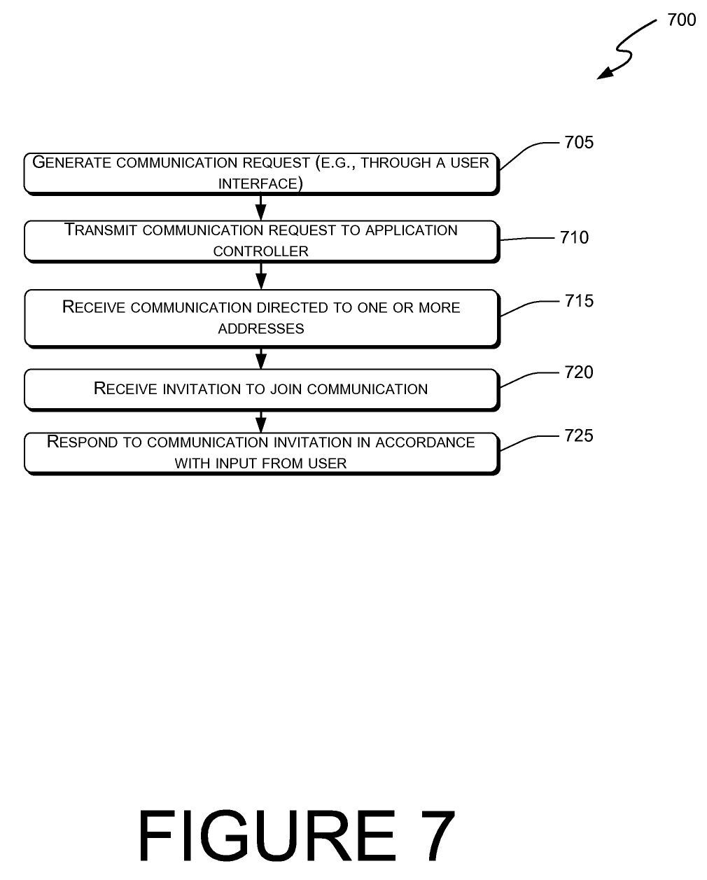

The functionality of the communications device 140, including the method depicted in FIG. 7 (in whole or in part), may be implemented through the processor 410 executing computer-readable instructions stored in the memory 420. The memory 420 may store any computer-readable instructions and data, including software applications, applets, and embedded operating code. The functionality of the communications device 140 may also be implemented through various hardware components (alone or in combination with software) as described previously for the application controller 110.

The communications device 140 includes a user interface 440, which may include any number of input devices (not shown) to receive commands, data, and other suitable input from a user, as well as any number of output devices (not shown) to provides the user with data, notifications, and other suitable information. The user interface 440 may include any of the features or systems described above for the application controller 110.

The communications interface 440 communicates with a data processing unit 120 and/or application controller 110 and can communicate in any desired manner. The communications interface 440 may be configured to communicate using any communication format, such as those described above with regards to the application controller 110 and/or the data processing unit 120. In one embodiment of the present invention, the communications interface 440 can extend the number of phone lines (or other addresses) available to the communications device 140 to any desired number. This is achieved by the data processing unit 120 managing incoming calls to the communications device 140 and allocating separate lines for each call. The user of the communications device 140 can perform a voice communication on a single line while putting the others on hold, as well as joining multiple lines into a conference call. The user can select and manage active lines using the user interface 430 on the communications device 140. The user can also be apprised as new lines become active and existing lines drop. A sideband data connection between the communications device 140 and the data processing unit 120 can be used to manage the lines. In this manner, the PBX system of the present invention allows a user to engage in conference calls with far more lines than conventional PBX systems allow.

An exemplary method that may be practiced in conjunction with a communications device 140 of the present invention is depicted in FIG. 7. In this method, the communications device 140 generates a communication request (705) and transmits the communication request (710), whether directly or through an intermediary such as a data processing unit 120 and/or network 130, to an application controller 110. The communications device 140 can also receive and handle a communication directed to one or more addresses (715), as well as receive an invitation to join a communication (720) and respond to the invitation (725).

The communications device 140 can generate any type of request in any format, as discussed previously for the application controller 110 and data processing unit 120. A communication can be addressed to one or more recipients (retrieved from a list of addresses stored in the communications device 140 or specified by a user through the user interface 430. In one embodiment, software executing on the communications device 140 examines the address of a recipient (such as the recipient's telephone number or email address) and determines whether to perform the communication through the PBX system of the present invention or to communicate directly with the recipient. In this manner, the communications device 140 can avoid burdening the PBX system with unnecessary traffic, as well as to perform the communication in fastest and/or most cost-effective manner possible.

Any combination and/or subset of the elements of the methods depicted herein may be practiced in any suitable order and in conjunction with any suitable system, device, and/or process. The methods described and depicted herein can be implemented in any suitable manner, such as through software comprising computer-readable instructions stored in a medium (such as the memory of an application controller 110, data processing unit 120, and/or communications device 140) and executed by one or more processors.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A system comprising:
a data processing unit;
an application controller in communication with the data processing unit, the application controller comprising:
a processor;
a user interface; and
a memory coupled to the processor and storing instructions that, when executed by the processor, cause the processor to:
receive a request for a communication through the data processing unit; and
instruct the data processing unit to perform the communication in accordance with the request.

2. The system of claim 1, wherein the memory further stores instructions to cause the processor to authenticate the request for the communication.

3. The system of claim 1, wherein the memory further stores instructions to cause the processor to determine whether the data processing unit is available to perform the communication.

4. The system of claim 1, wherein the communication is selected from the group consisting of:
an electronic mail message;
an SMS text message;
a facscimile;
an audio communication;
a voice message;
a video communication;
a group communication;
a conference communication; and
combinations thereof.

5. The system of claim 4, wherein the communication is a conference communication selected from the group consisting of:
a spontaneous conference communication;
a bridge conference communication;
a reach-out conference communication;
a multi-location communication; and
combinations thereof.

6. The system of claim 1, further comprising a plurality of data processing units in communication with the application controller, wherein the memory further stores instructions to cause the processor to:
instruct at least one of the plurality of data processing units to perform the communication based on at least one of:
a communication format for at least one of the plurality of data processing units;
a cost of communicating via a wireless carrier associated with at least one of the plurality of data processing units;
a physical location of at least one of the plurality of data processing units; and
a usage status of at least one of the plurality of data processing units.

7. The system of claim 6, wherein the plurality of data processing units includes at least one data processing unit configured to communicate in a first communication format and at least one data processing unit configured to communicate in a second communication format.

8. The system of claim 6, wherein at least a portion of the plurality of data processing units are dedicated to the application controller for a predetermined period of time.

9. The system of claim 6, wherein at least a portion of the plurality of data processing units are shared with another application controller.

10. The system of claim 6, wherein the application controller comprises a data processing unit.

11. The system of claim 1, wherein the memory further stores instructions to cause the processor to configure the data processing unit to communicate in a predefined wireless communications format.

12. The system of claim 1, wherein the memory further stores instructions to cause the processor to:
analyze the request; and
in the event that the request does not include information necessary to perform the communication, solicit a source of the request for the necessary information.

13. The system of claim 1, wherein the memory further stores instructions to cause the processor to:
analyze the request to identify one or more recipients of the communication;
retrieve information on the one or more recipients; and
provide the information on the one or more recipients to the data processing unit.

14. The system of claim 1, further comprising a user interface, wherein the memory further stores instructions to cause the processor to:
receive, through the user interface, commands from a user for configuring the data processing unit; and
provide the user, through the user interface, information on the status of the data processing unit.

15. A system comprising:
a plurality of data processing units;
a plurality of application controllers in communication with the plurality of data processing units, wherein each application controller comprises:
a processor;
a user interface; and
a memory coupled to the processor and storing instructions that, when executed by the processor, cause the processor to:
receive a request for a communication from one or more of the data processing units; and
instructing one or more of the plurality of data processing units to perform the communication in accordance with the request.

16. The system of claim 15, wherein for at least one application controller, the memory of the at least one application controller further stores instructions to cause the processor of the at least one application controller to authenticate the request for the communication.

17. The system of claim 15, wherein for at least one application controller, the memory of the at least one application controller further stores instructions to cause the processor of the at least one application controller to determine whether the one or more data processing units are available to perform the communication.

18. The system of claim 15, wherein the communication is selected from the group consisting of:
an electronic mail message;
an SMS text message;
a facscimile;
an audio communication;
a voice message;
a video communication;
a group communication;
a conference communication; and
combinations thereof.

19. The system of claim 18, wherein the communication is a conference communication selected from the group consisting of:
a spontaneous conference communication;
a bridge conference communication;
a reach-out conference communication;
a multi-location communication; and
combinations thereof.

20. The system of claim 15, wherein for at least one application controller, the memory of the at least one application controller further stores instructions to cause the processor of the at least one application controller to cause the processor to:
provide the request to at least one of the plurality of data processing units based on at least one of:
a communication format of at least one of the plurality of data processing units;
a cost of communicating via a wireless carrier associated with at least one of the plurality of data processing units;
a physical location of at least one of the plurality of data processing units; and
a usage status of at least one of the plurality of data processing units.

21. The system of claim 15, wherein the plurality of data processing units includes at least one data processing unit configured to communicate in a first communication format and at least one data processing unit configured to communicate in a second communication format.

22. The system of claim 15, wherein at least a portion of the plurality of data processing units are dedicated to at least one of the plurality of application controllers for a predetermined period of time.

23. The system of claim 15, wherein at least a portion of the plurality of data processing units are shared by at least a portion of the plurality of application controllers.

24. The system of claim 15, wherein at least one of the plurality of application controllers comprises a data processing unit.

25. The system of claim 15, wherein for at least one application controller, the memory of the at least one application controller further stores instructions to cause the processor of the at least one application controller to:
configure at least one of the plurality of data processing units to communicate in a predefined wireless communications format.

26. The system of claim 15, wherein for at least one application controller, the memory of the at least one application controller further stores instructions to cause the processor of the at least one application controller to:
analyze the request; and
in the event that the request does not include information necessary to perform the communication, solicit a source of the request for the necessary information.

27. The system of claim 15, wherein for at least one application controller, the memory of the at least one application controller further stores instructions to cause the processor of the at least one application controller to:
analyze the request to identify one or more recipients of the communication;
retrieve information on the one or more recipients; and
provide the information on the one or more recipients to one or more of the plurality of data processing units.

28. The system of claim 15, wherein at least one of the plurality of application controllers further comprises a user interface, wherein the memory of the at least one application controller further stores instructions to cause the processor of the at least one application controller to:
receive, through the user interface, commands from a user for configuring at least one of the plurality of data processing units; and
provide a user, through the user interface, information on the status of at least one of the plurality of data processing units.
